(19) United States
(12) Patent Application Publication
(10) Pub. No.: US 2013/0318861 A1
(43) Pub. Date: Dec. 5, 2013

(54) BED BUG TRAP DEVICE

(71) Applicant: Daniel Roeder, Ida Grove, IA (US)

(72) Inventor: Daniel Roeder, Ida Grove, IA (US)

(21) Appl. No.: 13/485,589

(22) Filed: May 31, 2012

(51) Int. Cl. A01M 1/10; A01M 1/00

(52) U.S. Cl. 43/123; 43/58

(57) ABSTRACT

A trap device for the capture of bed bugs is provided. The device may be used under, or in association with, furniture or other objects in which crawling arthropods or pests may infest. The device includes a base with an exterior side wall extending upward from its perimeter. The base of the device forms the floor of the confinement area of the device and the upper edge of the exterior side wall includes an arcuate lip that is connected to a protruding cantilevered ledge spaced above the floor of the confinement area. The device also includes a platform for accepting furniture legs and the like. The platform includes another arcuate lip that connects with another protruding cantilevered ledge that is also spaced above the floor of the confinement area. The cantilevered ledges preclude the bugs from escaping the confinement area of the trap device.

### FIELD OF THE INVENTION

The invention provides for an interception and containment device for crawling arthropods that can be placed under, or near, affected furniture or other supported objects (such as beds, chairs, sofas, luggage, etc.). This allows for the capture of bed bugs and other crawling pests without the use of pesticides and other chemicals.

### BACKGROUND OF THE INVENTION

The bed bug, Cimex lectularius of the Family Cimicidae, has been a blood-sucking pest for many generations. The adult bed bug's key features are a length of 6-9 mm, with a flattened, oval, wingless shape and reddish-brown color. They lack tarsal pads and are required to climb vertical surfaces using tarsal hooks that they embed in suitably rough material. Bed bugs are primarily active at night but are not considered to be exclusively nocturnal. They hide in unnoticed crevices and fabric seams which make their detection difficult.

Most U.S. homeowners of the last generation have not had to deal with bed bugs due to the widespread use of DDT in the 1940s and 1950s as well as other pesticides in later years. However, the effectiveness of DDT and other pesticides was quickly reduced as bed bugs became resistant to each pesticide as the use of each became more prevalent. The resistance to pesticides among bed bug populations has caused a resurgence in bed bugs and dramatically increased infestations, especially in hotels, resorts, college dormitories, and apartments.

The use of alternative containment measures used against bed bugs has grown in recent years, partially due to the growing ineffectiveness of pesticides against bed bugs. There are many variations of traps used to fight bed bug infestations; one such common trap is the pitfall trap. Sensory lures are also sometimes used in conjunction with traps to attract the bed bugs into the trap.

Often, sensory lures used to attract bed bugs to traps include: heat, chemical attractants (such as carbon dioxide), and odors. Heat is used as a lure because bed bugs are attracted to particular temperature ranges from heat sources as they often indicate warm-blooded bodies from which the bed bugs may feed. Carbon dioxide and odor lures are also used to attract bed bugs because they are indications of a food source for the bugs.

The use of sensory lures is known in the art, for example, U.S. Pat. No. 5,205,064 to Nolen, U.S. Pat. No. 5,382,422 to Dieguez, U.S. Pat. No. 5,799,436 to Nolen, U.S. Pat. No. 6,055,766 to Nolen, U.S. Pat. No. 6,145,243 to Wigton, U.S. Pat. No. 6,199,316 to Coventry, U.S. Pat. No. 6,305,122 to Iwao, U.S. Pat. No. 6,516,559 to Simchoni, published U.S. Patent Application No. 2004/0025412 to Simchoni, U.S. Pat. No. 6,718,687 to Robinson, U.S. Pat. No. 6,898,896 to McBride, U.S. Pat. No. 7,074,830 to Durand, U.S. Pat. No. 7,243,458 to Miller, U.S. Pat. No. 5,189,830 to Montemurro, European Patent No. 1745697 to Geier, European Patent No. WO 9826661 to Justus, U.S. Pat. No. 5,900,244 to Howes, U.S. Pat. No. 6,106,821 to Baker, U.S. Pat. No. 6,593,299 to Bennet, U.S. Pat. No. 6,800,279 to Bernier, U.S. Pat. No. 6,866,858 to Nolen, U.S. Pat. No. 6,920,716 to Kolars, U.S. Pat. No. 5,657,576 to Nicosia, U.S. Pat. No. 7,117,632 to Lin, U.S. Pat. No. 5,258,176 to Keenan, U.S. Pat. No. 4,907,366 to Balfour, Japan Patent No. JP-A-59062504, published U.S. Patent Application No. 2007/0044372, and published U.S. Patent Application No. 2009/0145020 all disclose the use and implementation of various lures to attract pests.

The pitfall trap is a common type of trap used to capture insects. A pitfall trap, in its most basic form, comprises a pit with interior walls that cannot be climbed. Proponents of the pitfall trap assert that it can be used to capture bed bugs because they are unable to climb out of a pit with smooth walls that their tarsal hooks cannot attach to. However, previous pitfall trap designs have a shortcoming in that bed bugs are often able to crawl/climb out of the pit, despite the smooth interior walls. Bed bugs are able to escape by either finding enough traction to attach their tarsal hooks and climb out of the pit or by climbing on top of other bed bugs and/or debris until they are able to escape.

The use of pitfall traps or traps with moats to prevent insects from climbing out is known in the art, for example, U.S. Pat. No. 2,790,417 to Brembeck, U.S. Pat. No. 5,277,149 to East, U.S. Pat. No. 3,441,003 to Du Mond et al., U.S. Pat. No. 5,148,626 to Haake, U.S. Pat. No. 5,253,609 to Partelow et al, U.S. Pat. No. 5,165,365 to Thompson, U.S. Pat. No. 5,113,798 to Rera, U.S. Pat. No. 4,128,080 to Haney, U.S. Pat. No. 5,125,363 to McGaha, U.S. Pat. No. 4,399,772 to Salinas, U.S. Pat. No. 4,608,774 to Sherman, and U.S. Patent Application No. 2009/0282728. U.S. Pat. No. 2,167,978 to Jennerich, U.S. Pat. No. 1,265,481 to Mosby, U.S. Pat. No. 944,568 to Mercer, U.S. Pat. No. 52,576 to Lamb, U.S. Pat. No. 533,017 to Peeler, and U.S. Pat. No. 21,726 to Shell all teach devices for trapping insects using pitfalls or moats.

### SUMMARY OF THE INVENTION

In accordance with the present invention, there is provided a novel trap device for capturing bed bugs and other similar crawling arthropods. The present invention provides an improved trap to capture and monitor crawling arthropods, especially bed bugs. The trap allows the capture of said bugs without using chemicals, attractants, or other toxic substances. Using a rounded lip and/or a cantilevered ledge for the trap, the trap device of the present invention is more effective than previous traps while not requiring the use of harmful compounds. An arcuate lip, edge, or rim of the trap increases the probability that the bed bugs will fall into the confinement area of the trap. The device can be placed either under, or in proximity to, furniture or similar objects on which the bed bugs climb.

In an illustrative embodiment of the invention, a novel climb-up pitfall trap is provided. The trap is made up of an outer or exterior, upward climbing wall, having an internal and external surface, with a rough finish on the external surface and a smooth finish on the internal surface. Furthermore, the upward climbing wall has a lower and upper edge with an arcuate lip lining the upper edge. This arcuate lip has a smooth surface and extends downward integral with a cantilevered ledge also having a smooth surface. The cantilevered ledge extends outward and integral with the internal surface of the upward climbing wall. A lower edge of the upward climbing wall is attached to, or integral with, the base of the trap. The base has an interior surface which constitutes the floor of the trap, or confinement, area.

A platform for receiving the supporting structure of the previously mentioned furniture or other supported objects extends upwards from the center of the base of the trap. A platform support member extends upward from the base of the trap and is integral with a radially extending planar interface member for receiving the supporting structure of the supported object. The planar interface member includes an arcuate lip about its perimeter that extends downward and is integral with a cantilevered ledge that protrudes toward and is integral with the platform support member.

The preferred embodiment of the present invention includes a rough surface finish on the external surface of the exterior wall to allow bed bugs to climb up the trap and smooth finishes to impede climbing on the following surfaces: the arcuate lip integral with the top edge of the exterior wall, the cantilevered ledge integral with the internal surface of the exterior wall, the internal surface of the exterior wall, the platform support member, the cantilevered ledge integral with the platform support member, the planar interface member, and the arcuate lip about the perimeter of the planar interface member. The present invention is an improvement on previous implementations as a bed bug trap to capture and allow for the detection of bed bugs as they attempt to infest furniture or other supported objects isolated by the trap as well as when the bugs attempt to depart an already infested object isolated by the trap.

The invention as set forth in one or more of the claims provides one or more of the following objectives:

It is an object to prevent bed bugs and other crawling arthropods from inhabiting or infesting furniture or other objects isolated by the present invention.

It is another object to capture and monitor bed bugs using the present invention.

It is yet another object to prohibit trapped bed bugs from escaping the confinement area of the present invention.

It is still another object to isolate the supporting structure(s) of furniture or other objects from the rest of the trap and confinement area so as to prevent bed bugs from reaching said supporting structure(s).

### BRIEF DESCRIPTION OF THE DRAWINGS

FIG. 1 is a perspective view of one embodiment of a bed bug trap in accordance with the present invention.

FIG. 2 is a top plan view of the bed bug trap of FIG. 1 in accordance with the present invention.

FIG. 3 is a bottom plan view of the bed bug trap of FIG. 1 in accordance with the present invention.

FIG. 4 is an elevation view of the bed bug trap of FIG. 1 in accordance with the present invention

FIG. 5 is a cross-sectional view taken along line 5-5 of FIG. 2 in accordance with the present invention.

FIG. 5A is an enlarged cross-sectional view showing the rounded lip and cantilevered ledge of the bed bug trap of FIG. 5 in accordance with the present invention.

FIG. 6 is a top plan view indicating the smooth and rough surfaces of the bed bug trap of FIG. 1 in accordance with the present invention.

FIG. 7 is a bottom perspective view of the bed bug trap of FIG. 5 indicating additional smooth surfaces in accordance with the present invention.

FIG. 8 is a perspective view of an alternative embodiment of the present invention.

FIG. 9 is a perspective view of another alternative embodiment of the present invention.

FIG. 10 is a perspective view of yet another alternative embodiment of the present invention.

### DETAILED DESCRIPTION OF THE INVENTION

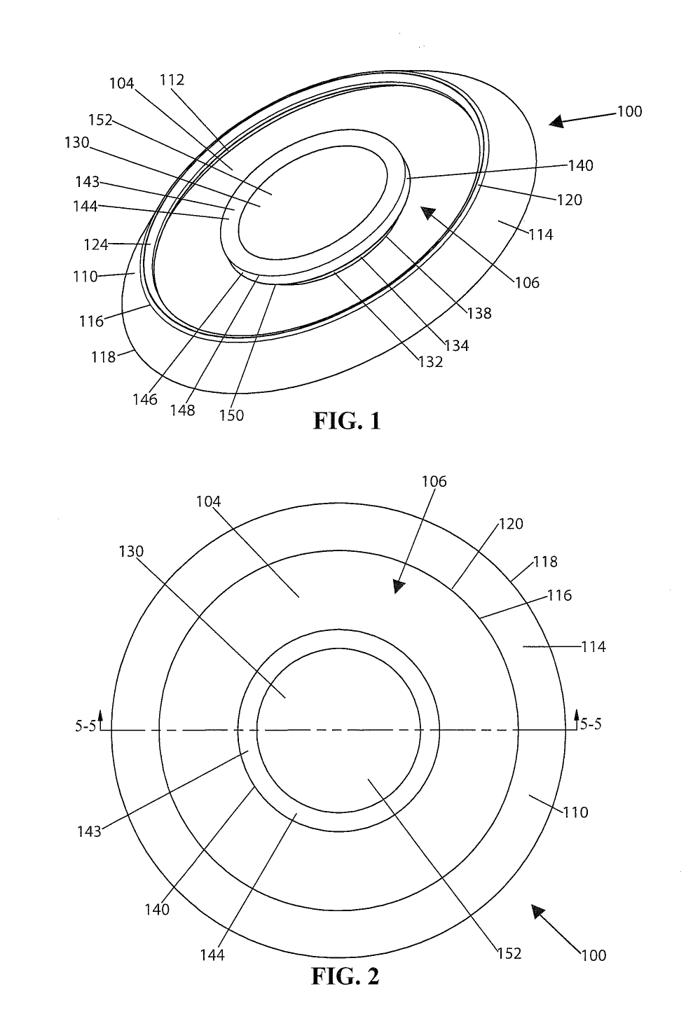

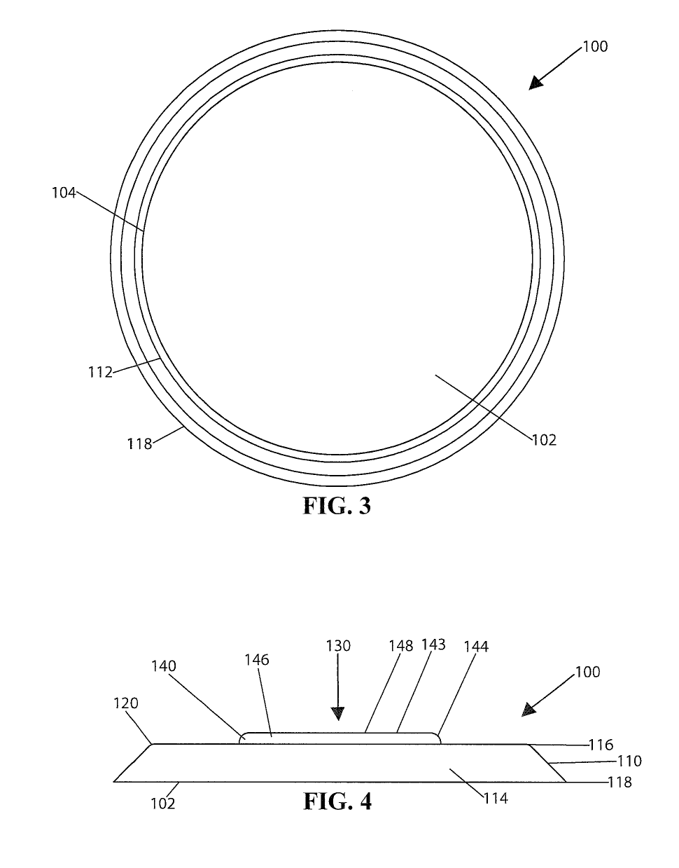

Referring to FIG. 1, a bed bug trap 100 of the present invention is shown. The bed bug trap 100 comprises a base 102 (FIG. 3) which forms the floor 104 of a confinement area 106 of the trap 100 and an exterior side wall, or climbing wall, 110 having an internal surface 112 and an external surface 114 as well as an upper edge 116 and a lower edge 118. The lower edge 118 of the exterior side wall 110 is integral with the perimeter of the base 102. The exterior side wall 110 extends upward and inward at an angle and is integral with an arcuate lip 120 at the upper edge 116 of the exterior side walls 110. The external surface 114 of the exterior side wall 110 has a rough finish that allows bed bugs and other arthropods to climb up to the arcuate lip 120 which, because of its shape, causes the bugs and/or other arthropods to fall into the confinement area 106 of the trap 100.

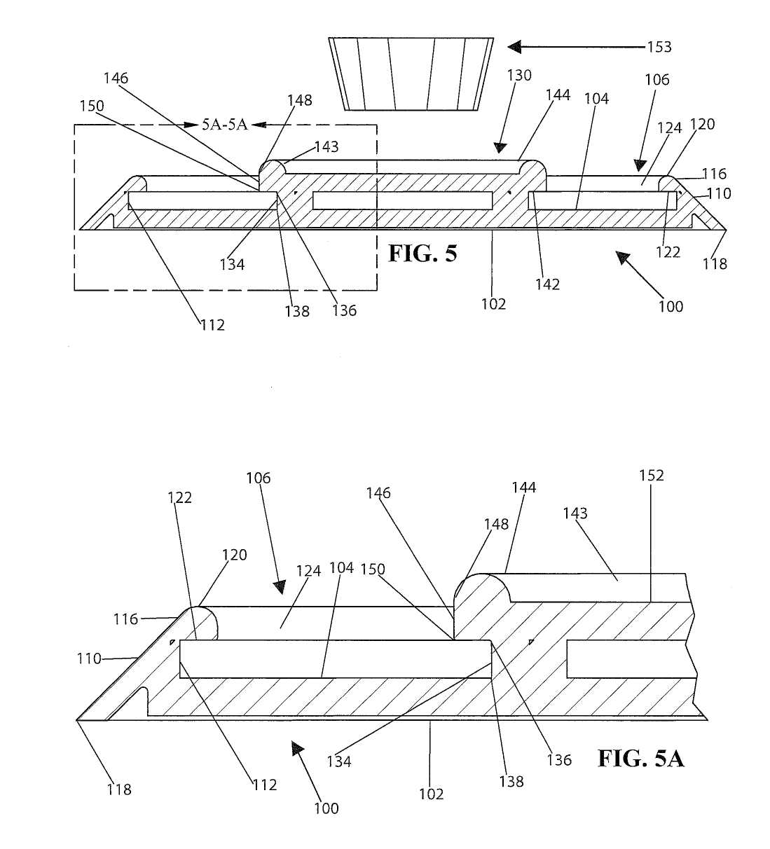

The arcuate lip 120 is also integral with a vertical surface 124 that connects the arcuate lip 120 with a cantilevered ledge 122 (FIG. 5). The cantilevered ledge 122 extends over and is spaced above a portion of the floor 104 of the confinement area 106. Furthermore, the cantilevered ledge 122 extends from the vertical surface 124 to the internal surface 112 of the exterior side wall 110. The cantilevered ledge 122 is impossible for a bed bug to navigate and also discourages and prohibits bed bugs and/or other crawling arthropods from climbing on top of one another or other debris to escape the confinement area 106. The confinement area 106 is bounded by the base 102, the internal surface 112 of the exterior side wall 110, and, partially, by the cantilevered ledge 122. The confinement area 106 as well as the arcuate lip 120 and vertical surface 124 all have a smooth finish which inhibits the bed bugs and/or arthropods from climbing out of the trap 100. It should be appreciated by one in the art, that variations to the finishes of the various surfaces, both smooth and rough, can be accomplished without changing the overall function or effectiveness of the trap 100.

A central platform 130 is attached to, or integral with, the base 102. The central platform 130 includes a cylindrical support member 132 and a radially extending, or protruding, planar interface member 140 which receives the support member of a piece of furniture or other supported object 153 to be protected. It should be appreciated by one in the art that, although the preferred embodiment shows the platform 130 to accept support members of a piece of furniture or other supported object 153, the device is also effective when placed adjacent to objects or on the ground without using the radially extending planar interface member 140. In addition, while the support member 132 is cylindrical in shape in the preferred embodiment, the cylindrical support member 132 and radially extending planar interface member 140 of the central platform can be of different shapes as will be discussed herein below. The cylindrical support member 132 of the central platform 130 extends upward comprising the interior side wall 134 of the confinement area 106 of the trap 100. The interior side wall 134, having a smooth finish, is further comprised of an upper edge 136 and a lower edge 138. The cylindrical support member 132 of the central platform 130 attaches to, or is integral with, the base 102 along the lower edge 138 of the interior side wall 134. The upper edge 136 of the interior side wall 134 attaches to, or is integral with, the radially extending planar interface member 140. Again, it should be appreciated by one skilled in the art that the trap 100 can be used with the central platform 130 receiving the supporting structure of a supported object 153, placing the device under the object, or with the trap 100 placed in proximity to the object without interfacing the supporting structure of the supported object 153 with the central platform 130.

In the preferred embodiment, the planar interface member 140 is circular in shape and includes a raised rim 143 around the perimeter of an interface surface 152. The raised rim 143 of the radially extending planar interface member 140 forms the boundary of the interface surface 152. The raised rim 143 keeps the supporting member of a piece of furniture or other supported object 153 from sliding off the radially extending planar interface member 140. It should be appreciated by one skilled in the art that the raised rim 143 of the radially extending planar interface member 140 can be deleted without affecting the overall function or effectiveness of the trap 100. The raised rim 143 includes an arcuate lip 144 integral with an upper edge 148 of a vertical surface 146 of the radially extending planar interface member 140 that extends downward and is integral with a cantilevered ledge 142 of the central platform 130 at a lower edge 150 of the vertical surface 146 (FIG. 5A). The cantilevered ledge of the central platform 130 extends over and is spaced above a portion of the floor 102 of the trap 100. Furthermore, the cantilevered ledge of the central platform 130 extends from the lower edge 150 of the vertical surface 146 of the radially extending planar interface member 140 to the upper edge 136 of the interior side wall 134 of the confinement area 106. It should be appreciated by one in the art that, although the preferred embodiment illustrates all surfaces of the central platform 130 to have a smooth finish, these finishes could be varied in their level of roughness and smoothness on the assorted surfaces of the platform 130 without affecting the overall function or effectiveness of the trap 100. Again, it should also be appreciated by one in the art that the overall shape of the radially extending planar interface member 140, the central platform 130, as well as the trap 100 can be modified without affecting the overall function or effectiveness of the trap 100.

FIG. 2 shows the exterior side wall 110 with both the lower edge 118 as well as the upper edge 116 of the exterior side wall 110 which is integral with the arcuate lip 120 shown. The figure also shows the external surface 114 of the exterior side wall 110, the floor 104 of the confinement area 106 as well as the interface surface 152 and raised rim 143 with the integral arcuate lip 144 of the radially extending planar interface member 140 of the central platform 130.

FIG. 3 provides a bottom plan view of the trap 100. In particular, FIG. 3 shows the lower edge 118 of the exterior side wall 110 as well as the base 102 of the trap 100. The base 102 of the trap 100 as well as the lower edge 118 of the exterior side wall 110 make contact with the floor or surface upon which the trap 100 is supported.

FIG. 4 particularly illustrates the exterior side wall 110, including its external surface 114, lower edge 118 and upper edge 116 which is integral with the arcuate lip 120, as well as a portion of the vertical surface 146 of the radially extending planar interface member 140 of the central platform 130, including its upper edge 148. Also shown in FIG. 4 is the raised rim 143 with integral arcuate lip 144 of the radially extending planar interface member 140 of the central platform 130.

FIG. 5 is a cross-sectional illustration of the trap 100 taken along the line of sight, labeled 5-5 in FIG. 2. FIG. 5 also shows a portion of a support member of a piece of furniture or other supported object 153 spaced slightly above the preferred placement. FIG. 5A is an enlarged view taken along the line of sight, labeled 5A-5A in FIG. 5. These figures particularly illustrate the exterior side wall 110, with both its lower edge 118 and upper edge 116 which is integral with the arcuate lip 120 of the exterior side wall 118. It should be noted again, that the shape of the arcuate lip 120 described creates a smooth steep surface that aids in causing the bed bug or other crawling arthropod to slip and fall into the confinement area 106 more easily. Because bed bugs and crawling arthropods climb using their tarsal hooks, they are unable to climb smooth surfaces that do not have enough texture for their tarsal hooks to cling to; therefore, they are unable to escape areas bounded by smooth surfaces such as the confinement area 106 of the preferred embodiment. Since bed bugs and other crawling arthropods are able to climb rough surfaces, especially when not scaling a steep gradient, the roughness of the exterior side wall is attractive for the bed bugs or other crawling arthropods to climb. FIGS. 5 and 5A also illustrates the vertical surface 124 that is integral with both the arcuate lip 120 and the cantilevered ledge 122. The cantilevered ledge 122 is shown extending from the vertical surface 124 to the internal surface 112 of the exterior side wall 110 which is also illustrated in FIG. 5. Again, it should be noted that the cantilevered ledge 122 of the present invention is impossible for bed bugs to navigate and also discourages and prohibits bed bugs and/or other crawling arthropods from climbing on top of one another or other debris to escape the confinement area 106. The internal surface 112 of the exterior side wall is also shown connected to the base 102 of the trap 100. The height of the confinement area 106 that is partially covered by the cantilevered ledge 122 of the exterior side wall 110 as well as the cantilevered ledge 142 of the central platform 130 is 0.25 inches in height in the preferred embodiment, thus making the internal surface 112 of the exterior side wall 110 as well as the interior side wall 134 of the confinement area 106 0.25 inches in height. However, it should be appreciated by one skilled in the art that the height of the partially covered regions of the confinement area 106 may be changed without changing the overall function or effectiveness of the trap 100 described in the present invention. The base 102 of the trap 100 is also shown in FIG. 5 along with the upper portion of the base 102 which forms the floor 104 of the confinement area 106.

Furthermore, FIG. 5 specifies the attachment of the central platform 130 to the base 102 by illustrating that the support member 132 of the central platform 130 attaches to the floor 104 of the confinement area 106 along the lower edge 138 of the interior side wall 134 and extends upward and attaches to, or is integral with, the radially extending planar interface member 140 of the central platform 130 along the upper edge 136 of the interior side wall 134. The radially extending, or protruding, planar interface member 140 in FIG. 5 includes the interface surface 152 bounded by and integral with the raised rim 143 with the integral arcuate lip 144 of the radially extending planar interface member 140. The arcuate lip 144 is shown integral with the upper edge 148 of the vertical surface 146 of the radially extending planar interface member 140. The vertical surface 146 is also integral with the cantilevered ledge 142 of the platform 130 along the lower edge 138 of the vertical surface 146. Finally, the cantilevered ledge 142 of the radially extending planar interface member 140 is shown extending from the lower edge 138 of the vertical surface 146 and integral with the upper edge 136 of the interior side wall 134 of the confinement area 106. Also shown above the radially extending planar interface member 140 of the central platform 130 is a portion of a support member of a piece of furniture or other supported structure 153 spaced slightly above the area of the radially extending planar interface member 140 it would come to rest on.

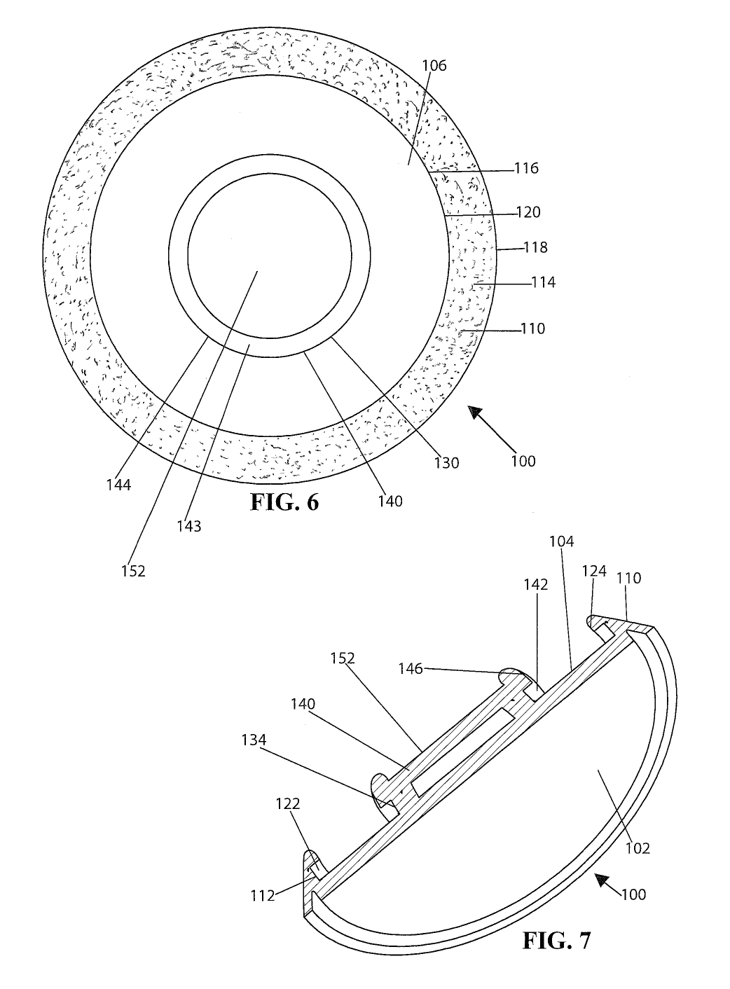

FIG. 6 is similar to FIG. 2 but details the rough and smooth finishes of the various surfaces. As shown by the stippling in FIG. 6, the exterior side wall 110, including the lower edge 118, upper edge 116, and external surface 114, have a rough finish to allow bed bugs and/or crawling arthropods and other pests to climb up the surface. The rest of the surfaces of the device, including the arcuate lip 120 of the exterior side wall 110, the floor of the confinement area 106, and the raised rim 143 with the integral arcuate lip 144 and the interface surface 152 of the radially extending planar interface member 140 of the central platform 130 all have a smooth finish in the illustrated embodiment of FIG. 6.

FIG. 7 further illustrates the surface finishes of the trap 100 using a bottom perspective view of the trap 100 shown in FIG. 5. FIG. 7 particularly shows the smooth finish of the cantilevered ledge 122 of the exterior side wall 110 as well as of the cantilevered ledge 142 of the central platform 130. It should be noted that the vertical surface 124 of the exterior side wall 110, the internal surface 112 of the exterior side wall 110, the interior side wall 134, and the vertical surface 146 of the radially extending planar interface member 140 of the central platform 130 all have smooth finishes as well. Again, it should be appreciated by one in the art that the rough and smooth finishes of the various surfaces of the trap 100 can be interchanged or altered without affecting the overall function or effectiveness of the trap 100.

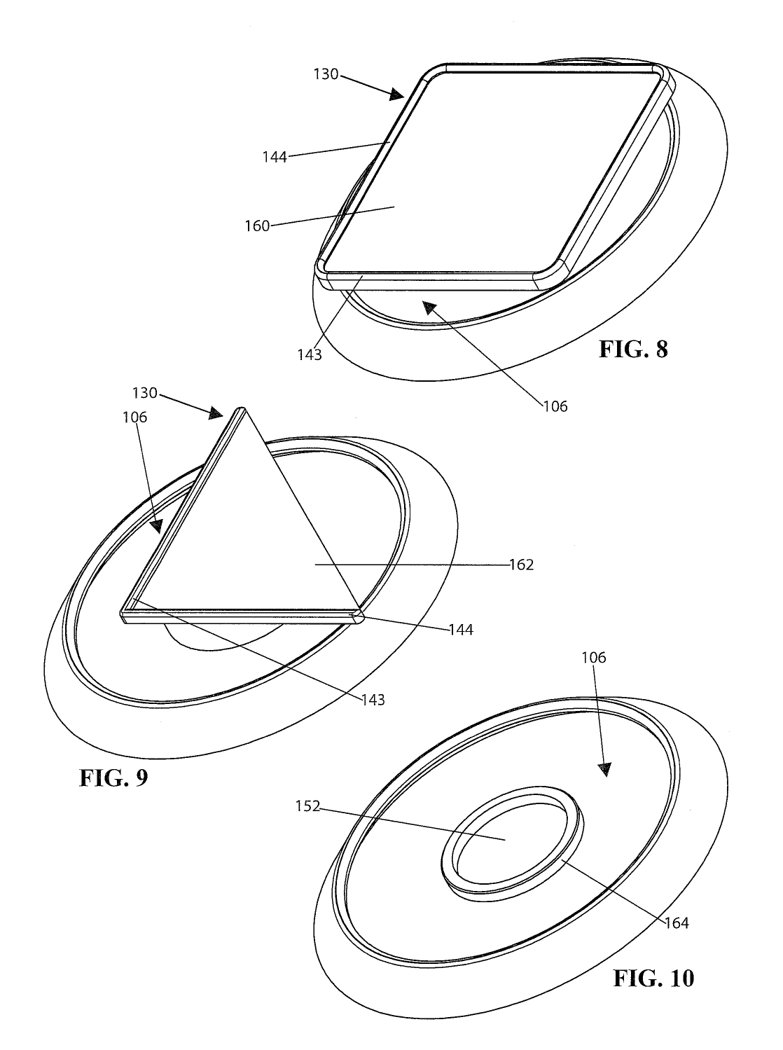

FIGS. 8-10 illustrate perspective views of alternative embodiments of the central platform 130 of the trap 100 as well as the remaining portions of the trap 100 as described in the preferred embodiment above. The trap in FIG. 8 allows for the use of a square interface member 160 of the central platform 130 with the same details as the radially extending planar interface member 140 of the central platform 130 described in the preferred embodiment above. FIG. 9 illustrates a trap using a triangular interface member 162 of the central platform 130 with the same details as the radially extending planar interface member 140 of the central platform 130 described in the preferred embodiment above; except the hypotenuse of the triangular interface member 162 illustrated in FIG. 9 is not bounded by the raised rim 143 and integral arcuate lip 144 illustrated in the radially extending planar interface member 140 in the preferred embodiment. Finally, the trap shown in FIG. 10 does not include a central platform 130 comprising only a raised attachment ring 164 attached to, or integral with, the base 102 as a barrier between the confinement area 106 and the support member of a piece of furniture or other supported object 153. It is further anticipated that the trap device 100 could be used without a central platform 130 or a raised attachment ring 164 but this is not preferred. It should be appreciated by one in the art that the trap 100 of the present invention can be designed with a user interchangeable and/or removable platform system based on the illustrations provided to describe the preferred and alternative embodiments of the present invention.

In practice, a bed bug approaches the trap 100 from the lower edge 118 of the exterior side wall 110 to climb the rough external surface 114 of the exterior side wall 110. The bug would then reach the smooth arcuate lip 120 integral with the upper edge 116 of the exterior side wall 110 and fall over the arcuate lip 120 into the confinement area 106 of the trap 100. The bed bug would be unable to navigate back out of the trap 100 or climb on top of other bed bugs or debris to escape the confinement area 106 due to the cantilevered ledge 122 extending from the lower portion of the arcuate lip 120 to the internal surface 112 of the exterior side wall 110 inhibiting the bed bugs from climbing out of the confinement area 106 of the trap 100. The surfaces of the cantilevered ledge 122 and the internal surface 112 of the exterior side wall 110 comprise a smooth surface finish further inhibiting the bed bugs from escaping. The smooth finish of the support member 132, cantilevered ledge 142, vertical surface 146, and arcuate lip 143 of the platform 130 inhibit a bed bug's ability to escape the confinement area 106 and reach the protected support member of a supported object 153. The cantilevered ledge 142 of the platform 130 further prevents bed bugs from escaping the confinement area 106 and reaching the protected support member of a supported object 153. The preferred embodiment's concept of trapping and inhibiting bed bugs from escaping also works for bed bugs that attempt to leave an already infested object placed above the trap 100 by allowing bed bugs that crawl down the support member of a supported object 153 to reach the arcuate lip 143 of the readially extending interface member 140 and fall over the arcuate lip 143 into the confinement area 106 of the trap 100.

The bed bug trap 100 of the preferred embodiment was tested along with previous prototypes. Prototype 1 signified a design of the trap which included a raised rim at the upper edge of the exterior side wall from which an arcuate lip extended downward towards a cantilevered ledge. It should be noted that the raised rim at the upper edge of the exterior side wall of Prototype 1 allowed bed bugs on the precipice of falling into the confinement area of the trap to cling to the raised rim and pull themselves back over to the external surface of the exterior side wall. Accordingly, a modified version (Prototype 2), which became the preferred embodiment, was adopted without the raised rim at the upper edge of the exterior side wall. Different examples of Prototype 2 which were tested varied only as to the height between the floor 104 of the confinement area 106 and the cantilevered ledge 122 on the exterior side wall 110 as well as the cantilevered ledge 142 of the central platform 130 as listed in the tables below. Prototype 2—1/4, having a height of 0.25 inches from the floor 104 of the confinement area 106 to the cantilevered ledge 122 of the exterior side wall 110, as well as from the floor 104 of the confinement area 106 to the cantilevered ledge 142 of the platform 130, was deemed most effective, and represents the preferred embodiment of the present invention.

The purpose of this testing was to address the following three questions: 1.) Can bed bugs crawl into the trap from the outside? 2.) Can bed bugs crawl out of the trap to the outside or up the central platform? 3.) Can bed bugs crawl into the trap from the central platform?

Bed bugs for the testing were obtained from an established colony at a well known research facility but originated from the Department of Entomology at the University of Kentucky and are known as the “Fort Dix” strain. This strain has never been exposed to an insecticide. Bed bugs were maintained at 25±5° C., approximate 50% humidity, and on a 12 hour light:dark photoperiod.

In an attempt to lure the bed bugs into the trap or around the trap, a heat source was used. Third to fourth-instar males were used for testing. Bed bugs were starved at least two weeks prior to testing. Bed bug traps were secured in an arena (tray) using masking tape; the masking tape secured the trap and prevented the bed bugs from crawling under the trap. Monitoring of their movement was performed at room temperature; movement was monitored for a 30-minute period.

Once the bed bugs were within the confinement area of the trap, none of them were able to escape from the inside of the trap to the outside or up the central platform in any of the prototypes. In all of the prototypes, bed bugs attempted to escape the trap by climbing the internal surface of the exterior side wall or up the central platform. The test concluded that once bed bugs were in the trap, either by being placed in the trap or falling into the trap, the bed bugs were unable to escape. While all of the prototypes trapped and contained the bed bugs, the preferred embodiment was deemed most effective.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, etc.) are to be construed broadly and may include intermediate members between a connection of elements and relative movements between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements, and/or substantial equivalents, whether known or that are or may be presently foreseen, may become apparent to those having at least ordinary skill in the art. Listing the steps of a method in a certain order does not constitute any limitation of the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

1. A device for the capture of crawling arthropods, comprising:
a. A base which forms the floor of a confinement area of said device;
b. An exterior side wall having an internal surface and external surface as well as a lower edge and upper edge;
c. Said lower edge of said exterior side wall integral with the perimeter of said base, said exterior side wall extending upward from said perimeter of said base;
d. Said upper edge of said exterior side wall extending downward to form a first cantilevered ledge; and
e. Said first cantilevered ledge extending from said upper edge to said internal surface of said exterior side wall and said first cantilevered ledge being spaced over and above a portion of said floor of said confinement area.

2. The device of claim 1 wherein said trap includes a platform for receiving a support member of a supported object, said platform comprising: a support member having an upwardly extending interior side wall with a lower edge and an upper edge, said support member attached to said base along said lower edge of said interior side wall and integral with an interface member at said upper edge of said interior side wall, said interface member including an interface surface to receive said support members of said supported object, said interface member which protrudes radially outwardly from said interior side wall to form a second cantilevered ledge extending over and spaced above a second portion of said floor of said confinement area.

3. The device of claim 1 wherein said upper edge of said exterior side wall comprises a first arcuate lip.

4. The device of claim 2 wherein said upper edge of said exterior side wall comprises a first arcuate lip and wherein said interface member of said platform is bounded along its perimeter by a second arcuate lip.

5. The device of claim 1 wherein said external surface of said exterior side wall consists of a rough surface finish.

6. The device of claim 2 wherein said upper edge of said exterior side wall, said first cantilevered ledge, said internal surface of said exterior side wall, said interior side wall of said support member of said platform, and said second cantilevered ledge of said platform consist of a smooth surface finish.

7. The device of claim 2 wherein said interface surface of said platform comprises a raised rim about its perimeter.

8. The device of claim 2 wherein said internal surface of said exterior side wall and said interior side wall, respectively form outer and inner boundaries of said confinement area.

9. The device of claim 2 wherein said first and second arcuate lips are integral with first and second vertical surfaces that connect said first and second arcuate lips with said first and second cantilevered ledges.

10. The device of claim 9 wherein said first and second arcuate lips, said first and second vertical surfaces, said first and second cantilevered ledges, said internal surface of said exterior side wall, and said interior side wall of said platform consist of a smooth surface finish.

11. A trap device for the capture of crawling arthropods, comprising:
a. A base which forms the floor of a confinement area of said trap device;
b. An exterior side wall having an internal surface and external surface as well as a lower edge and upper edge;
c. Said lower edge of said exterior side wall integral with the perimeter of said base, said exterior side wall extending upward from said perimeter of said base;
d. Said upper edge of said exterior side wall having a first arcuate lip;
e. Said first arcuate lip extending downward and integral with a first cantilevered ledge that extends from said first arcuate lip to said internal surface of said exterior side wall, said first cantilevered ledge being spaced over and above a portion of said floor of said confinement area;
f. A platform connected to said base for receiving a support member of a supported object;
g. Said platform extending upward from said base and including an interior side wall having a lower edge and an upper edge;
h. Said lower edge of said interior side wall attached to said base;
i. Said upper edge of said interior side wall integral with a radially outwardly protruding interface member having a second arcuate lip about its perimeter; and
j. Said second arcuate lip of said interface member extending downward and integral with a second cantilevered ledge that extends from said second arcuate lip to said interior side wall of said platform, said second cantilevered ledge extending over and spaced above a second portion of said floor of said confinement area.

12. The device of claim 11 wherein said external surface of said exterior side wall consists of a rough surface finish.

13. The device of claim 11 wherein said first and second arcuate lips, said first and second cantilevered ledges, said internal surface of said exterior side wall, and said interior side wall consist of a smooth surface finish.

14. A trap device for the capture of bed bugs, comprising:
a. A base which forms the floor of a confinement area of said trap device;
b. An exterior side wall having an internal surface and an external surface as well as a lower edge and an upper edge;
c. Said lower edge of said exterior side wall integral with the perimeter of said base, said exterior side wall extending upward and inward, at an angle, from said perimeter of said base;
d. Said upper edge of said exterior side wall having a first arcuate lip;
e. Said first arcuate lip integral with a first vertical surface extending downward;
f. Said first vertical surface integral with a first cantilevered ledge extending over and spaced above a first portion of said floor of said confinement area;
g. Said confinement area bounded by said base and said internal surface of said exterior side wall;
h. Said first cantilevered ledge extending from said first vertical surface to said internal surface of said exterior side wall;
i. Said base integral with a centrally located platform for receiving a support member of a supported object;
j. Said central platform extending upward from said base and having a cylindrical support member and a radially extending planar interface member with a second arcuate lip about its perimeter;
k. Said cylindrical support member forming an interior side wall having a vertical surface as well as a lower edge and an upper edge;
l. Said lower edge of said interior side wall attached to said base and said upper edge of said interior side wall integral with said radially extending planar interface member of said central platform;
m. Said radially extending planar interface member protruding outwardly from said cylindrical support member to form a second cantilevered ledge extending over and spaced above a second portion of said floor of said confinement area; and
n. Said second arcuate lip of said radially extending planar interface member of said central platform integral with a second vertical surface extending downward to integrate with said second cantilevered ledge.

15. The device of claim 14 wherein said external surface of said exterior side wall consists of a rough surface finish.

16. The device of claim 14 wherein said first and second arcuate lips, said first and second cantilevered ledges, said vertical surface of said interior side wall, and said internal surface of said exterior side wall consist of a smooth surface finish.
